(19) United States
(12) Patent Application Publication
(10) Pub. No.: US 2016/0269510 A1
(43) Pub. Date: Sep. 15, 2016

(54) CONTENT EVALUATOR, CONTENT EVALUATION SYSTEM, SERVER UNIT AND TERMINAL UNIT TO EVALUATE CONTENT

(71) Applicant: Co-Growth Inc., Tokyo (JP)

(72) Inventors: Bumpei SASAKI, Tokyo (JP); Masanori NAKAGAWASAI, Tokyo (JP)

(73) Assignee: Co-Growth Inc.

(21) Appl. No.: 15/164,872

(22) Filed: May 26, 2016

Related U.S. Application Data
(63) Continuation of application No. PCT/JP2014/081417, filed on Nov. 27, 2014.

(30) Foreign Application Priority Data
Nov. 29, 2013 (JP) 2013-246960

(51) Int. Cl. H04L 29/06

(52) U.S. Cl. CPC H04L 67/42

(57) ABSTRACT

The purpose of the present invention is to provide an evaluation method, a device, a system, a server device and a terminal device that enable a viewer to evaluate a live performance or content during the viewing thereof, and to re-evaluate, for example, an interesting part of the live performance or content subsequent to the viewing thereof. The evaluation method according to the present invention is characterized by including: a primary evaluation information reception step for receiving primary evaluation information including a primary evaluation of content; a content segment generation step for generating a content segment, which is a part of the content, in accordance with the primary evaluation information; a content segment display step for displaying the content segment; and a secondary evaluation information reception step for receiving secondary evaluation information including a secondary evaluation of the content segment.

### CROSS-REFERENCES TO RELATED APPLICATIONS

This application claims the benefit of priority and is a Continuation application of the prior International Patent Application No. PCT/JP2014/081417, with an international filing date of Nov. 27, 2014, which designated the United States, and is related to the Japanese Patent Application No. 2013-246960, filed Nov. 29, 2013, the entire disclosures of all applications are expressly incorporated by reference in their entirety herein.

### BACKGROUND OF THE INVENTION

1. Field of the Invention

To provide a content evaluator, a content evaluation system, a server unit, and a terminal unit for enabling a viewer to evaluate a live performance or a recorded content during auditing or viewing, and to re-evaluate, for example, a part of the live performance or the recorded content which draws a viewer or an auditor's attention after viewing.

2. Description of Related Art

As a method of evaluating a content, the following “Patent document 1” is known, wherein a content viewer sends an evaluation information indicating positive or negative reaction at each moment the content viewer reacted, and a server unit tallies a number of positive or negative reactions. [Patent document 1] JP,2003-30105,A

### BRIEF SUMMARY OF THE INVENTION

In the method of “Patent document 1”, it was difficult to collect precise and detailed evaluations, since evaluations are made during a content viewing. The present invention is made in view of the above-mentioned point. The present invention provides a content evaluator, a content evaluation method, a content evaluation system, a server unit, and a terminal unit for enabling a viewer to evaluate a live performance or a recorded content during auditing or viewing, and to re-evaluate, for example, a part of the live performance or the recorded content which draws an auditor or a viewer's attention after viewing

A content evaluator invented compromises: a primary evaluation accepter which accepts a primary evaluation and records the primary evaluation, the primary evaluation being made by sequentially evaluating a content, the primary evaluation including an evaluation time-point information indicating a point of time that each of the primary evaluation is made; a content piece extractor which identifies an extraction part in accordance with the primary evaluation and generates a content piece as a part of the content in accordance with the extraction part; a content piece presenter which presents the content piece; and a secondary evaluation acceptor which accepts a secondary evaluation on the content piece.

A content evaluation method invented compromises: a primary evaluation information acceptance step of accepting a primary evaluation, the primary evaluation being made by sequentially evaluating a content, the primary evaluation including an evaluation time-point information indicating a point of time that each of the primary evaluation is made; a content piece extraction step of identifying an extraction part in accordance with the primary evaluation and generates a content piece as a part of the content in accordance with the extraction part; a content; a content piece presentation step of presenting the content piece; and a secondary evaluation acceptance step of accepting the secondary evaluation on the content piece.

And a content evaluation system invented compromises: a primary evaluation accepter which accepts a primary evaluation and records the primary evaluation, the primary evaluation being made by sequentially evaluating a content, the primary evaluation including an evaluation time-point information indicating a point of time that each of the primary evaluation is made; a primary evaluation information sender which sends the primary evaluation information a through data transmission path; a primary evaluation information receiver which receives the primary evaluation information through the data transmission path; a content piece extractor which identifies an extraction part in accordance with the primary evaluation and generates a content piece as a part of the content in accordance with the extraction part; a content piece sender which sends the content piece through the data transmission path; a content piece receiver which receives the content piece through the data transmission path; a secondary evaluation acceptor which accepts a secondary evaluation on the content piece; a secondary evaluation information sender which sends the secondary evaluation information through the data transmission path;

a secondary evaluation information receiver which receives the secondary evaluation information through the data transmission path.

And a server unit invented compromises: a primary evaluation accepter which accepts a primary evaluation and records the primary evaluation, the primary evaluation being made by sequentially evaluating a content, the primary evaluation including an evaluation time-point information indicating a point of time that each of the primary evaluation is made, the primary evaluation is sent through a data transmission path; a content piece extractor which identifies an extraction part in accordance with the primary evaluation and generates a content piece as a part of the content in accordance with the extraction part; a content piece sender which sends the content piece through the data transmission path; a secondary evaluation information receiver which receives the secondary evaluation information through the data transmission path.

And a terminal unit invented compromises: a primary evaluation accepter which accepts a primary evaluation and records the primary evaluation, the primary evaluation being made by sequentially evaluating a content, the primary evaluation including an evaluation time-point information indicating a point of time that each of the primary evaluation is made; a primary evaluation information sender which sends the primary evaluation information through the data transmission path; a content piece receiver which receives a content piece through the data transmission path; a secondary evaluation acceptor which accepts a secondary evaluation on the content piece.

### BRIEF DESCRIPTION OF THE DRAWINGS

FIG. 1 is a drawing of a system of an embodiment 1 of the present invention.

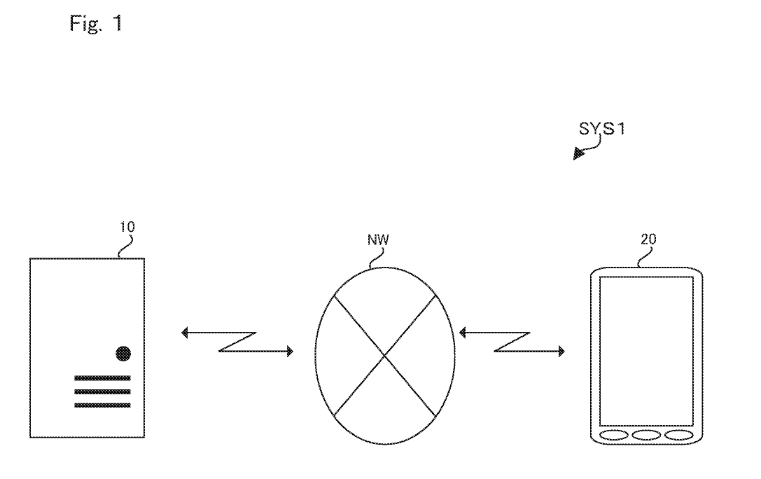

FIG. 2 is a block diagram showing a composition of the server unit of the system of FIG. 1.

FIG. 3 is a block diagram showing a composition of the terminal unit of the system of FIG. 1.

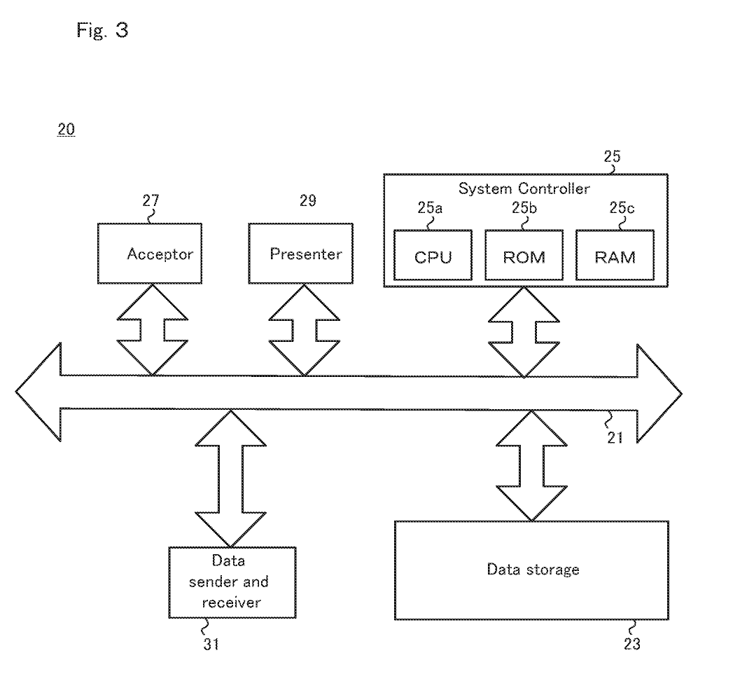

FIG. 4 is a flow chart of an evaluation routine for realizing the content evaluator and the content evaluation system of the embodiment 1 of the present invention.

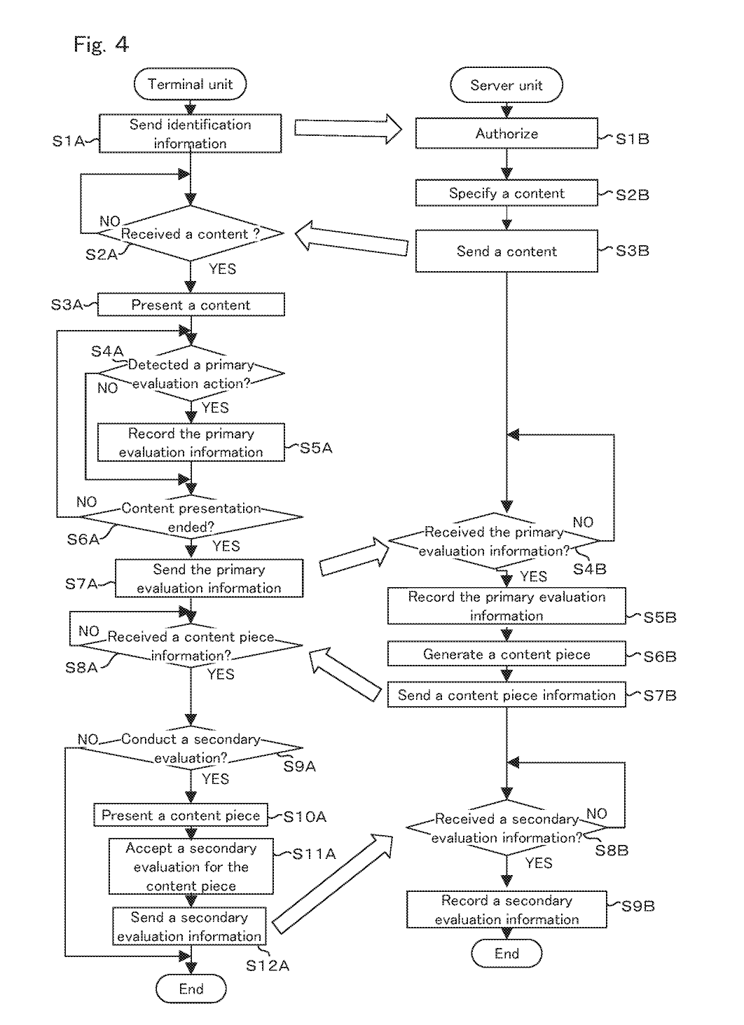

FIG. 5 is an example of a screen of the terminal unit accepting the primary evaluation.

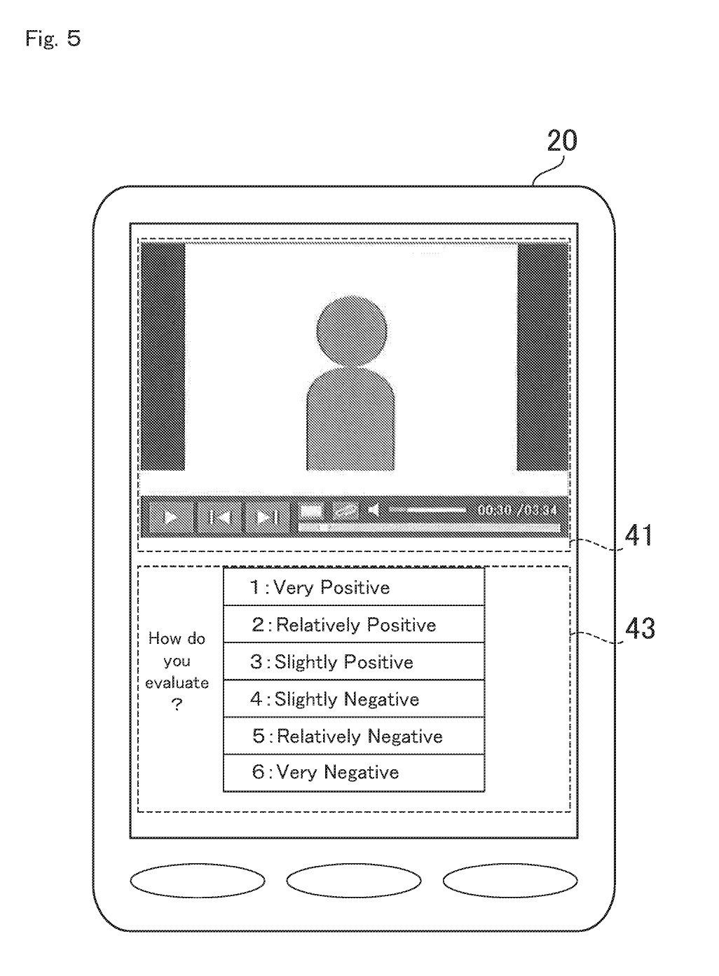

FIG. 6 is an example of a screen of the terminal unit accepting the secondary evaluation.

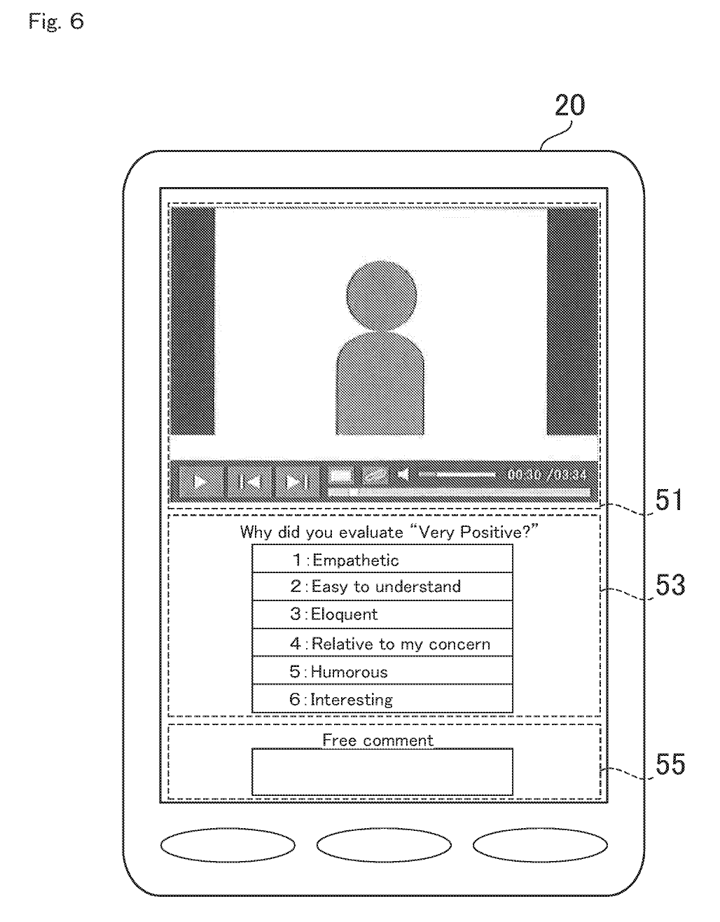

FIG. 7 is an example of a screen of the terminal unit accepting secondary evaluation.

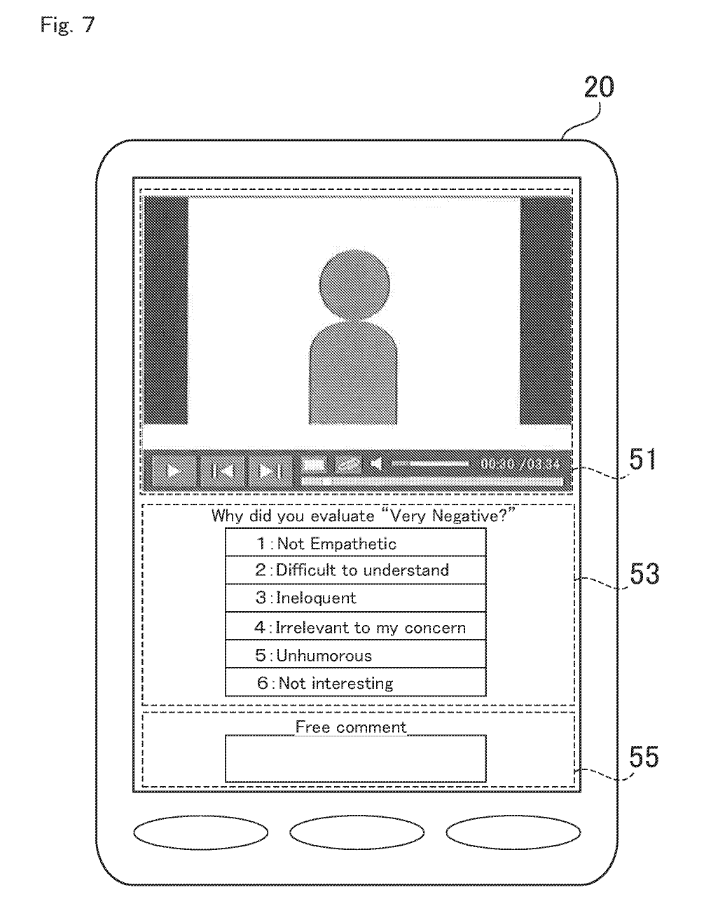

FIG. 8 is a drawing of a system of an embodiment 2 of the present invention.

FIG. 9 is a flow chart of an evaluation routine for realizing the content evaluator and the content evaluation system of the embodiment 2 of the present invention.

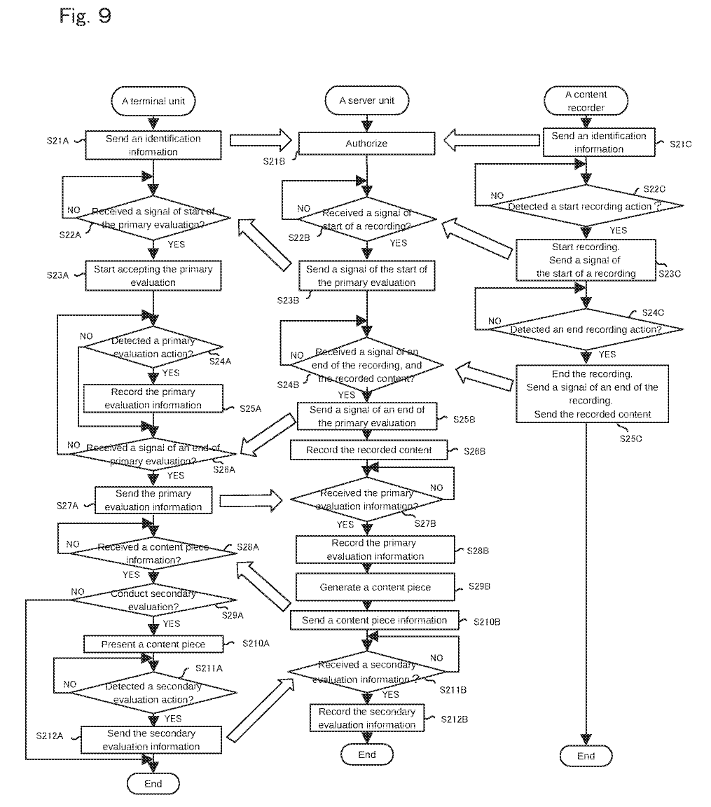

### DETAILED DESCRIPTION OF THE INVENTION

### The Embodiment 1

A content evaluator including a server unit and a terminal unit of the embodiment 1 of the present invention is described in the following sentences while referring to the attached drawings. Drawing 1 shows a content evaluator SYS1 which is the embodiment 1 of the present invention. As shown in Drawing.1, the content evaluator SYS1 is comprised of a server unit 10 (an example of the “server unit”), and a terminal unit 20 (an example of the “terminal unit”) which a viewer or an auditor who evaluates a content operates. Although the example of Drawing 1 shows only one terminal unit 20, multiple terminal units may be connected to the server unit 10.

The server unit 10 and the terminal unit 20 are able to mutually send and receive data through a network NW (a transmission path) using communications protocols, such as TCP/IP. Examples of the network NW are the Internet, LAN (Local Area Network), leased line network such as CATV (Community Antenna Television) circuit, a mobile communications network (a base station etc. are included), a gateway, etc.

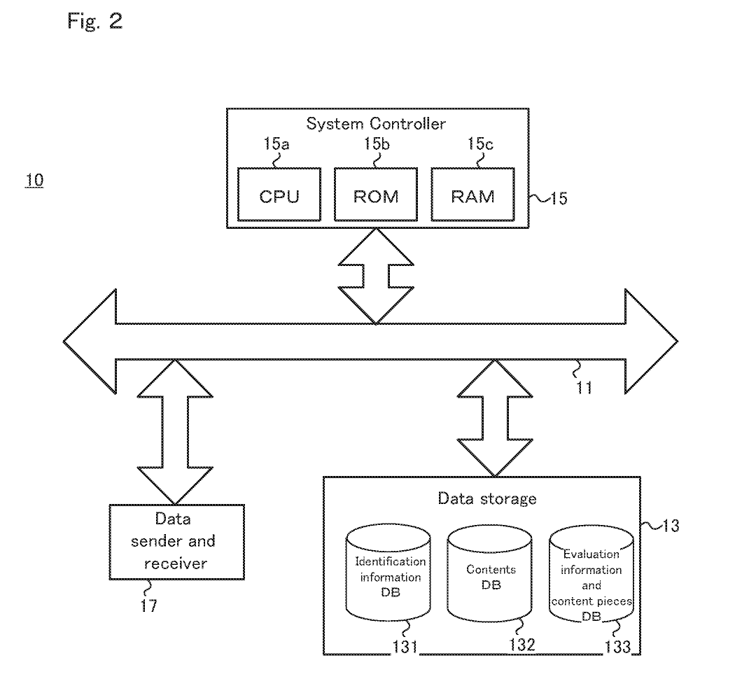

FIG. 2 shows a composition of the server unit 10. In this example, the server unit 10 is composed of a data storage 13, a system controller 15, and a data sender and receiver 17, and those components are connected and coordinated through a system bus 11.

The data storage 13 may be a hard disk drive, SSD (solid state drive), etc. It can hold various programs, such as an operating system and other software for the server unit. Those various programs may be acquired through the network NW or any recording medium such as CDs and DVDs. Namely, the various programs (including a program to collect and process evaluation information described in the following sentences) may be transmitted through the network NW, and any recording medium. In addition, the data storage 13 has an identification information DB 131, a contents DB132, an evaluation information and content pieces DB 133.

The system controller 15 is composed of a CPU (Central Processing Unit) 15a, a ROM (Read Only Memory) 15b, a RAM (Random Access Memory) 15c, etc., and functions as a computer. The CPU 15a reads and runs various programs recorded in the ROM 15b and the data storage 13 to achieve certain functions.

The data sender and receiver 17 is connected to the above-mentioned network NW. It sends and receives various data to and from other apparatus, such as the terminal unit 20.

Drawing 3 shows a composition of the terminal unit 20. In this example, the terminal unit 20 is composed of a data storage 23, a system controller 25, an accepter 27, a presenter 29, and a data sender and receiver 31, and those components are connected and coordinated through a system bus 21. The terminal unit 20 may be a smart phone, a personal computer (PC), a tablet PC, a feature phone, and a PDA (Personal Digital Assistant).

The data storage 23 may be a hard disk drive, SSD (solid state drive), flash memories. It can hold various programs, such as an operating system and other software for the terminal unit 23. Those various programs may be acquired through the network NW or any recording medium such as CDs and DVDs. Namely, the various programs (including a program to perform functions of the terminal unit 20 described in the following sentences) may be transmitted through the network NW, and any recording medium.

The system controller 25 is composed of a CPU (Central Processing Unit) 25a, a ROM (Read Only Memory) 25b, a RAM (Random Access Memory) 25c, etc., and functions as a computer. The CPU 25a reads and runs various programs recorded in the ROM 25b and the data storage 23 to achieve certain functions.

The accepter 27 may be a keyboard, a mouse, a touchpad, a touch panel, a stylus pen, a speech input system, an acceleration sensor, and an inclination sensor etc. The presenter 29 may be a display, a speaker etc. The data sender and receiver 31 is connected to the above-mentioned network NW. It sends and receives various data to and from other apparatus, such as the terminal unit 20.

[An Evaluation Routine of the Embodiment 1]

With reference to Drawing 4, an evaluation routine to realize the evaluator embodiment 1 is described below.

To start, the terminal unit 20 sends identification information to the server unit 10 through a data transmission path. A content information to evaluate may be sent spontaneously (Step S1A). Correspondingly, the server unit 10 records the received identification information on the identification information DB 131, and processes authorization (Step S1B). The terminal unit 20 stands by until receiving a content from the server unit 10 (step S2A: NO), after sending the identification information.

Next, the server unit 10 specifies a content which a viewer or an auditor evaluates based on the identification information and the content information received in the former step (step S2B), reads the specified content from the contents DB 132, and sends it to the terminal unit 20 (Step S3B). When the terminal unit 20 receives the content (step S2A: YES), the terminal unit 20 presents (plays) the content (Step S3A).

While presenting the contents, the terminal unit 20 accepts and records a primary evaluation (a simple and intuitive evaluation such as “positive” or “negative”). In other words, the primary evaluation is made by sequentially evaluating a content Specifically, for example, the terminal unit 20 displays a screen drown in the Drawing 5, and monitors a primary evaluation until an end of a content presentation. (step S4A: NO, step S6A: NO). In the screen example shown in Drawing 5, a content is displayed in a content presentation area 41, and alternatives of evaluation are displayed in an evaluation alternatives area 43.

The primary evaluation may be conducted by touching an alternative displayed such as shown in Drawing 5 (“Very Positive”, “Relatively Positive”, “Slightly Positive”, “Slightly Negative”, “Relatively Negative”, “Very Negative”) while presenting a content, or when the accepter 27 is a keyboard, the primary evaluation action may be conducted by pushing a key associated with each alternative. In addition, it is not necessary that the primary evaluation is conducted at a viewer or an auditor's arbitrary moment. It may be conducted periodically, or conducted for each scene.

When the primary evaluation action is detected (Step S4A: YES), the terminal unit 20 records the primary evaluation information containing time-point information (Step S5A). When the terminal unit 20 recognizes the end of the content (step S6A: YES), it sends the primary evaluation information recorded in Step S5A to the server unit 10 (Step S7A).

On the other hand, the server unit 10 stands by until it receives the primary evaluation information from the terminal unit 20, after processing of S3B (step S4B: NO). When the terminal unit 20 sends the primary evaluation information (Step S7A), and the server unit 10 receives the primary evaluation information (step S4B: YES), the server unit 10 records the received primary evaluation information on the evaluation information and content piece DB 133 (Step S5B), generates a content piece based on the primary evaluation information recorded, and records the information of the content piece on the evaluation information and content piece DB 133 (Step S6B).

The content piece is a part of a content, extracted by identifying the part in accordance with the primary evaluation. One content piece may be a consecutive part of a content, or intermittent parts of a content. The content piece may be generated by, for example, extracting a part of which a starting point is a certain period of time (30 seconds, for example) before the primary evaluation action and an ending point is a certain period of time after the primary evaluation action. The certain period of time may be set arbitrarily. Another example of methods of the content piece generation is extracting a part which contains large amount of the primary evaluation of same direction (for example, “Positive”). To identify a part, primary evaluations may be converted to a numerical value. For example, “3” for “Very Positive”, “2” for “Relatively Positive”, “1” for “Slightly Positive”, “−1” for “Slightly Negative”, “−2” for “Relatively Negative” and “−3” for “Very Negative”.

To list more examples of methods of the content piece generation, when multiple terminal unit 20 evaluating a same content exist, the server unit 10 may identify a part to extract and generate the content piece in accordance with the primary evaluation information sent from those multiple terminal unit 20 by synthesizing or comparing the primary evaluation information from each terminal unit 20. A content piece may be generated for each terminal unit 20, or for all terminal unit 20.

The terminal unit 20 stands by until it receives a content piece information from the server unit 10 (step S8A: NO), after processing of S7A. The server unit 10 sends the generated content piece information after processing of S6B to the terminal unit 20 (step S7B). When the terminal unit 20 receives the content piece information (Step S8A: YES), it inquires a viewer or an auditor whether or not to conduct a secondary evaluation by presenting an inquiry. If a viewer or an auditor responds not to conduct (step S9A: NO), the terminal unit 20 ends processing according to this flow chart.

If a viewer or an auditor responds to conduct the secondary evaluation (Step S9A: YES), a secondary evaluation mode is performed and the terminal unit 20 presents (plays) the content piece received (Step S10A). After processing of S10A, the terminal unit 20 waits for the secondary evaluation action, which is an evaluation to the content piece, and accept it (Step S11A).

Examples of the secondary evaluation are shown in Drawing 6 and Drawing 7. The secondary evaluation may be an evaluation different and more precise from the primary evaluation, such as shown in Drawing 6 for a content piece with positive primary evaluation, and such as shown in Drawing 7 for a content piece with negative primary evaluation.

In a screen example shown in Drawing 6 and Drawing 7, the content piece is presented on a content piece display area 51, alternatives of evaluation are displayed on an evaluation alternatives area 53, and a free comment box is displayed on a free comment area 55. The secondary evaluation may be accepted after finishing a presentation (play) of a content (meanwhile all the primary evaluation finishes), or during a presentation (play) of a content (meanwhile the primary evaluation is continued to be accepted). Timing and length of accepting the secondary evaluation may be arbitrary.

The secondary evaluation action may be conducted by touching an alternative displayed such as shown in Drawing 6 and Drawing 7, or when the accepter 27 is a keyboard, the secondary evaluation action may be conducted by pushing a key associated with each alternative. The secondary evaluation may be a free comment input into the free comment box. The secondary evaluation may overwrite the primary evaluation, such as changing from “Positive” to “Negative”.

The server unit 10 stands by until it receives the secondary evaluation information from the terminal unit 20 (Step S8B: NO), after processing of S7B. The terminal unit 20 sends the secondary evaluation information to the server unit 10 (Step S12A), after processing of S11A, and ends processing according to this flow chart. The secondary evaluation information may contain time-point information. When the server unit 10 receives the secondary evaluation information (Step S8B: YES), it associates the secondary evaluation information to the content piece, and records on the evaluation information and content pieces DB 133 (step S212B), and ends processing according to this flow chart.

The embodiment 1 is the evaluator, the evaluation system, and embodiment 1 is composed of the server unit and the terminal unit.

The embodiment 1 as the evaluator, components to process S4A (detected a primary evaluation action?), S5A (record the primary evaluation information) correspond to the primary evaluation accepter.

Components to process S6B (generate a content piece) correspond to the content piece extractor.

Components to process S10A (present a content piece) correspond to the content piece presenter.

Components to process S11A (accept a secondary evaluation for the content piece) correspond to the secondary evaluation acceptor.

Embodiment 1 as an evaluation system, components to process S4A (detected a primary evaluation action?), S5A (record the primary evaluation information) correspond to the primary evaluation accepter.

Components to process S7A (send the primary evaluation information) correspond to the primary evaluation information sender.

Components to process S4B (received the primary evaluation information?) correspond to the primary evaluation information receiver.

Components to process S6B (generate a content piece) correspond to the content piece extractor.

Components to process S7B (send a content piece information) correspond to the content piece sender.

Components to process S8A (received a content piece information?) correspond to the content piece receiver.

Components to process S11A (accept the secondary evaluation for the content piece) correspond to the secondary evaluation acceptor.

Components to process S12A (send the secondary evaluation information) correspond to the secondary evaluation information sender.

Components to process S9B (received the secondary evaluation information?) correspond to the secondary evaluation information receiver.

Embodiment 1 as a server unit, components to process S4B (received the primary evaluation information?) and S5B (Record the primary evaluation information) correspond to the primary evaluation information receiver.

Components to process S6B (generate a content piece) correspond to the content piece extractor.

Components to process S7B (send a content piece information) correspond to the content piece sender.

Components to process S9B (received the secondary evaluation information?) correspond to the secondary evaluation information receiver.

Embodiment 1 as a terminal unit, components to process S4A (detected a primary evaluation action?), S5A (record the primary evaluation information) correspond to the primary evaluation accepter.

Components to process S7A (send the primary evaluation information) correspond to the primary evaluation information sender.

Components to process S8A (received a content piece information?) correspond to the content piece receiver.

Components to process S11A (accept the secondary evaluation for the content pieces) correspond to the secondary evaluation acceptor.

In step S4A-S7A, while the embodiment 1 sends the primary evaluation information collectively after an end of presentation of a content, the primary evaluation information may be sent to the server unit 10 one by one, when the primary evaluation action is detected.

In step S7B and S8A, while in the case of the embodiment 1, the content piece information includes the content piece itself, the content piece information may include only time-point information and information to identify a content, and may not include the content piece itself. In this case, the content piece may be generated in the terminal unit 20.

The evaluator, the evaluation system, the server unit and the terminal unit of the embodiment 1 enables to conduct simple and intuitive primary evaluations while viewing a live performance or a recorded content, and enables to conduct the secondary evaluation which is different and more precise from the primary evaluation. In other expression, by extracting the content pieces according to the primary evaluation, and by accepting re-evaluation to the content pieces, a viewer or an auditor can precisely evaluate a content.

The information saved in the identification information DB 131, in the contents DB132, in the evaluation information and content pieces DB133, can be accessed from arbitrary terminal devices. This enables a creator of a content to view the primary evaluation and the secondary evaluation, and revise the content accordingly, for example.

Furthermore, the terminal unit 20 may process all the above-mentioned routines. That is, a content is preliminarily saved in the terminal unit 20 and the terminal unit 20 presents (plays) the content (step S3A), accepts the primary evaluation (step S4A-S6A), generates the content piece in accordance with the primary evaluation (step S6B), presents the content piece (Step S10A), and accepts the secondary evaluation (Step S11A).

In this case, the terminal unit 20 accepts and records the primary evaluation through processing step S4A, S6A, S7A, S4B, S5B, and this corresponds to a primary evaluation accepter.

The terminal unit 20 specifies a part of a content to extract in accordance with the primary evaluation, and generates the content piece through processing S6B. This corresponds to a content piece extractor.

The terminal unit 20 presents the content piece through processing S7B, S8A, S10A. This corresponds to a content piece presenter.

The terminal unit 20 accepts the secondary evaluation through processing S10A, S11A, S8B, S9B. This corresponds to a secondary evaluation acceptor.

In addition, position information obtained by GPS etc. may be included in the primary evaluation information and the secondary evaluation information. The position information may be included as metadata of the primary evaluation information and the secondary evaluation information, and the position information concerned itself may serve as the primary evaluation or the secondary evaluation. For example, the primary evaluation and the secondary evaluation may be conducted by detecting a place an evaluation is conducted, or a place an evaluation is sent.

### The Embodiment 2

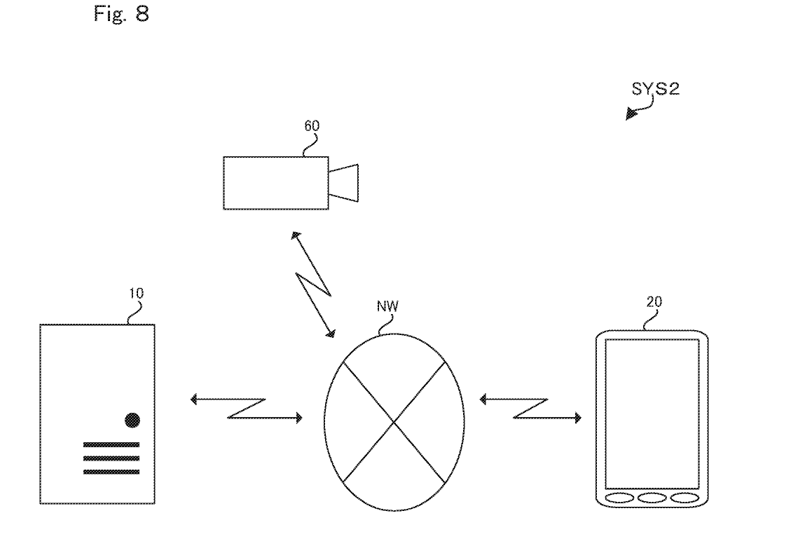

A content evaluator including a server unit and a terminal unit of the embodiment 2 of the present invention is described in the following sentences while referring to the attached drawings. FIG. 8 shows a content evaluator SYS2 which is the embodiment 2 of the present invention. As shown in Drawing.8, the content evaluator SYS2 is comprised of a server unit 10 (an example of the “server unit”), and a terminal unit 20 (an example of the “terminal unit”) which a viewer or an auditor who evaluates a content operates, and a content recorder 60. Although the example of Drawing 8 shows only one terminal unit 20, multiple terminal units may be connected to the server unit 10.

The server unit 10, the terminal unit 20 and the content recorder 60 are able to mutually send and receive data through a network NW (a transmission path) using communications protocols, such as TCP/IP. Examples of the network NW are the Internet, LAN (Local Area Network), leased line network such as CATV (Community Antenna Television) circuit, a mobile communications network (a base station etc. are included), a gateway, etc.

The server unit 10 and the terminal unit 20 have the same composition as the server unit 10 and the terminal unit 20 of the embodiment 1. The content recorder 60 is a terminal unit which has a function to record at least one of an image of the content and a sound of the content, and the content recorder 60 has a function to send a recorded information through the network NW. The content recorder 60 may be a smart phone, a personal computer (PC), a tablet PC, a feature phone, and a PDA (Personal Digital Assistant) etc. with a recording function.

### [An Evaluation Routine of the Embodiment 2]

With reference to Drawing 9, an evaluation routine to realize the evaluator embodiment 2 is described below.

To start, the terminal unit 20 sends identification information to the server unit 10 through a data transmission path. A content information of a live performance to evaluate may be sent spontaneously (Step S21A). Meanwhile, the content recorder 60 sends identification information to the server unit 10 through the data transmission path. A content information of a live performance to record may be sent spontaneously (Step S21C). Correspondingly, the server unit 10 records the received identification information on the identification information DB 131, and processes authorization (Step S21B).

The terminal unit 20 stands by until detecting a signal of start of the primary evaluation from the server unit 10 (step S22A: NO), after S21A. Meanwhile, the content recorder 60 stands by until detecting a start recording action to the content recorder 60 (step S22C: NO), after S21A.

When the content recorder 60 detected the start recording action (step S22C: YES), the content recorder 60 sends a signal of the start of recording to the server unit 10, and starts recording a live performance (Step S23C). The signal of the start of recording includes time-point information, and may include other information.

When the server unit 10 received a signal of start of recording (step S22B: YES), the server unit 10 sends a signal of start of the primary evaluation to the terminal unit 20 (Step S23B). When the terminal unit 20 received the signal of start of the primary evaluation (step S22A: YES), the terminal unit 20 stars accepting the primary evaluation (Step S23A).

On the other hand, the content recorder 60 stands by until it detects an end recording action (step S24C: NO), after processing of S23C. The server unit 10 stands by until it detect a signal of an end of recording and the recorded content sent from the content recorder 60, after processing of Step S23B (step S24 B:NO). When the content recorder 60 detected an end recording action (step S24C: YES), the content recorder 60 ends the recording, and send a signal of an end of the recording, and the recorded content, to the server unit 10 (Step S25C), and ends processing according to this flow chart. When the server unit 10 received a signal of an end of the recording, and the content recorded, from the content recorder 60 (step S24B: YES), it sends a signal of an end of the primary evaluation (Step S25B), and records the recorded content on the contents DB 132 (Step S26B).

The terminal unit 20 accepts and records the primary evaluation, as same as the routine 1 the embodiment 1. Specifically, the terminal unit 20 displays a screen drown in the Drawing 5, and monitors the primary evaluation until an end of a content presentation. (step S24A: NO, step S26A: NO). In the case of the embodiment 2, the primary evaluation may be sequential evaluation to the live performance ongoing. In the case of the embodiment 2, content presentation area 41 may exist, or may not exist. When exist, content presentation area may present s live streaming movie etc. In addition, it is not necessary that the primary evaluation is conducted at a viewer or an auditor's arbitrary moment. It may be conducted periodically, or conducted for each scene.

The primary evaluation may be conducted by touching an alternative displayed such as shown in Drawing 5 (“Very Positive”, “Relatively Positive”, “Slightly Positive”, “Slightly Negative”, “Relatively Negative”, “Very Negative”), or when the accepter 27 is a keyboard, the primary evaluation action may be conducted by pushing a key associated with each alternative.

When the primary evaluation action is detected (Step S24A: YES), the terminal unit 20 records the primary evaluation information containing time-point information (Step S25A). When the terminal unit 20 received a signal of an end of the content (step S26A: YES), it sends the primary evaluation information recorded in Step S25A to the server unit 10 (Step S27A).

The server unit 10 stands by until it receives the primary evaluation information from the terminal unit 20, after processing of S26B (step S27B: NO). When the server unit 10 received the primary evaluation information (step S27B: YES), the server unit 10 records the received primary evaluation information on the evaluation information and content piece DB 133 (step S28B).

The server unit 10 generates a content piece based on the primary evaluation information recorded, and records the information of the content piece on the evaluation information and content piece DB 133 (Step S29B), after processing of S28B.

The content piece is a part of the content of the live performance recording, extracted by identifying the part in accordance with the primary evaluation. One content piece may be a consecutive part of a content, or intermittent parts of a content. The content piece may be generated by, for example, extracting a part of which a starting point is a certain period of time (30 seconds, for example) before the primary evaluation action and an ending point is a certain period of time after the primary evaluation action. The certain period of time may be set arbitrarily. Another example of methods of the content piece generation is preliminarily dividing the live performance or the recorded content into several sections, and extracting a section which contains large amount of the primary evaluation of same direction (for example, “Positive”).

To list more examples of methods of the content piece generation, when multiple terminal unit 20 evaluating a same content lively performed exist, the server unit 10 may identify a part to extract and generate the content piece in accordance with the primary evaluation information sent from those multiple terminal unit 20 by synthesizing or comparing the primary evaluation information from each terminal unit 20. A content piece may be generated for each terminal unit 20, or for all terminal unit 20.

The terminal unit 20 stands by until it detects a content piece information from the server unit 10 (step S28A: NO), after processing of S27A. The server unit 10 sends the generated content piece information after processing of S29B to the terminal unit 20 (step S210B). When the terminal unit 20 detects the content piece information (Step S28A: YES), it inquires a viewer or an auditor whether or not to conduct a secondary evaluation by presenting an inquiry. If a viewer or an auditor responds not to conduct (step S29A: NO), the terminal unit 20 ends processing according to this flow chart.

If a viewer or an auditor responds to conduct the secondary evaluation (Step S29A: YES), a secondary evaluation mode is performed and the terminal unit 20 presents (plays) the content piece received (Step S210A). After processing of S210A, the terminal unit 20 waits for the secondary evaluation action, which is an evaluation to the content piece, and accept it (Step S211A).

In the same manner as the embodiment 1, the secondary evaluation may be an evaluation different and more precise from the primary evaluation, such as shown in Drawing 6 for a content piece with positive primary evaluation, and such as shown in Drawing 7 for a content piece with negative primary evaluation.

In the same manner as the embodiment 1, the secondary evaluation action may be conducted by touching an alternative displayed such as shown in Drawing 6 and Drawing 7, or when the accepter 27 is a keyboard, the secondary evaluation action may be conducted by pushing a key associated with each alternative. The secondary evaluation may be a free comment input into the free comment box.

The server unit 10 stands by until it receives the secondary evaluation information from the terminal unit 20 (Step S211B: NO), after processing of Step S210B. The terminal unit 20 sends the secondary evaluation information to the server unit 10 (Step S212A), after processing of Step S211A, and ends processing according to this flow chart. The secondary evaluation information may contain time-point information. When the server unit 10 receives the secondary evaluation information (Step S211B: YES), it associates the secondary evaluation information to the content piece, and records on the evaluation information and content pieces DB 133 (step S212B), and ends processing according to this flow chart.

The evaluator, the evaluation system, the server unit and the terminal unit of the embodiment 1 enables to conduct simple and intuitive primary evaluations while viewing a live performance or a recorded content, and enables to conduct the secondary evaluation which is different and more precise from the primary evaluation. In other expression, by extracting the content pieces according to the primary evaluation, and by accepting re-evaluation to the content pieces, a viewer or an auditor can precisely evaluate a live performance or a recorded content.

The information saved in the identification information DB 131, in the contents DB132, in the evaluation information and content pieces DB133, can be accessed from arbitrary terminal devices. This enables a live performer to view the primary evaluation and the secondary evaluation, and improve the live performance accordingly, for example.

Furthermore, when the content recorder 60 is equipped with an output function such as image output or an audio output, for example a PC or a smart phone, or a tablet PC etc., the server unit 10 may send the primary evaluation information and the secondary evaluation information to the content recorder, after detecting the secondary evaluation information (step S211B). This case enables a live performer staying in the same place as the content recorder 60 to see the primary evaluation and the secondary evaluation, without accessing the server unit 10 from another terminal unit.

Furthermore, when the content recorder 60 is equipped with an input function, for example a PC or a smart phone, or a tablet PC etc., the content recorder 60 may process S28A-S212A. In the other expression, the content recorder 60 may accept the secondary evaluation. This case enables a live performer to hear an evaluation while a viewer or an auditor conducted the primary evaluation is inputting the secondary evaluation.

In step S210B and S28A, while in the case of the embodiment 1, the content piece information includes the content piece itself, the content piece information may include only time-point information and information to identify a content, and may not include the content piece itself. In this case, the terminal unit 20 obtain and record the content on itself before S28A, and the content piece may be generated in the terminal unit 20. And in the case the content recorder process S28A-S212 as mentioned above, the content recorder 60 may receive the content piece information including time-point information to identify the content piece, and the content recorder 60 may generate the content piece.

In addition, position information obtained by GPS, by detecting the place the primary evaluation or the secondary evaluation conducted etc., may be included in the primary evaluation information and the secondary evaluation information. The position information may be included as metadata of the primary evaluation information and the secondary evaluation information, and the position information concerned itself may serve as the primary evaluation or the secondary evaluation. For example, the primary evaluation and the secondary evaluation may be conducted by detecting a place an evaluation is conducted, or a place an evaluation is sent. Utilization of GPS information may serve to improve the quality of an evaluation. For example, utilization of GPS enables to exclude the primary evaluation conducted in the place apart from the place a live performance conducted.

The content recorder 60 may process all the above-mentioned routines. That is, records at least one of an image of the content and a sound of the content (step S22C-S25C), accepts the primary evaluation (step S23A-S26A), generates the content piece in accordance with the primary evaluation (step S29B), presents the content piece (Step S210A), and accepts the secondary evaluation (step S211A).

The embodiment 2 is the evaluator, the evaluation system, and embodiment 1 is composed of the server unit and the terminal unit.

Embodiment 2 as the evaluator, components to process S24A (detected a primary evaluation action?), S25A (record the primary evaluation information) correspond to the primary evaluation accepter.

Components to process S29B (generate a content piece) correspond the content piece extractor.

Components to process S210A (present a content piece) correspond to the content piece presenter.

Components to process S211A (detected a secondary evaluation action?) and S211B received a secondary evaluation?) and S212B (record the secondary evaluation information) correspond to the secondary evaluation acceptor.

Components to process S23C (Start recording. Send a signal of the start of a recording) correspond to the content recorder, consolidated with the primary evaluation accepter and the secondary evaluation acceptor.

Embodiment 2 as the evaluation system, components to process S24A (detected a primary evaluation action?), S25A (record the primary evaluation information) correspond to the primary evaluation accepter.

Components to process S27A (send the primary evaluation information) correspond to the primary evaluation information sender.

Components to process S27B (received the primary evaluation information?) correspond to the primary evaluation information receiver.

Components to process S29B (generate a content piece) correspond to the content piece extractor.

Components to process S210B (send a content piece information) correspond to the content piece sender.

Components to process S28A (received a content piece information?) correspond to the content piece receiver.

Components to process S211A (detected a secondary evaluation action?), S211B received a secondary evaluation?) and S212B (record the secondary evaluation information) correspond to the secondary evaluation acceptor.

Components to process S212A (send the secondary evaluation information) correspond to the secondary evaluation information sender.

Components to process S211B (received the secondary evaluation information?) correspond to the secondary evaluation information receiver.

Embodiment 2 as a server unit, components to process S27B (received the primary evaluation information?) and S28B (Record the primary evaluation information) correspond to the primary evaluation information receiver.

Components to process S29B (generate a content piece) correspond to the content piece extractor.

Components to process S210B (send a content piece information) correspond to the content piece sender.

Components to process S28A (received a secondary evaluation information?) correspond to the secondary evaluation information receiver.

Embodiment 2 as a terminal unit, components to process S24A (detected a primary evaluation action?), S25A (record the primary evaluation information) correspond to the primary evaluation accepter.

Components to process S27A (send the primary evaluation information) correspond to the primary evaluation information sender.

Components to process S28A (received a content piece information?) correspond to the content piece receiver.

Components to process S211A (detected a secondary evaluation action?), S211B received a secondary evaluation?) and S212B (record the secondary evaluation information) correspond to the secondary evaluation acceptor.

[Input Methods of the Primary Evaluation and the Secondary Evaluation]

While some examples of input methods are described in the above-mentioned embodiments, an input method of the primary evaluation and the secondary evaluation is not restricted to those described in the above-mentioned embodiments. For example, an input method of the primary evaluation may be scrolling a wheel equipped in a mouse when using a mouse as the input component, or tapping, flipping and swiping when using a touch panel as the input component. A controller equipped with a three-axis gyroscope or an acceleration sensor is another example of an input method. In this case, inclining, shaking and waiving are examples of an input action, and the evaluation content is determined by referring to a sensor information such as a gradient, direction, speed and size of waiving, a number of shaking etc. A camera is another example of an input method. In this case, motion gesture captured by an image recognition may be an input action. A audio input device is another example of an input method. In this case, volume, pitch, and tone of sound or voice may be used to determine an evaluation content. Furthermore, in case of audio input, voice recognition may be used to determine an evaluation content.

[Form of the Primary Evaluation]

While some examples of forms are described in the above-mentioned embodiments, a form of the primary evaluation is not restricted to those described in the above-mentioned embodiments. For example, a form of the primary evaluation may be simply inputting a point score, or selecting from alternatives such as shown in the secondary evaluation. Furthermore, a viewer or an auditor may indicate a willingness to conduct the secondary evaluation to a certain point of a content, so that the content extractor generates the content piece which include the certain point (for example, the content piece of which a starting point is a certain period of time before the point the indication is made and an ending point is a certain period of time after the point the indication is made).

[A Generation Method of the Content Piece]

While some examples of methods of generating the content piece are described in the above-mentioned embodiments, a method of generating the content piece is not restricted to those described in the above-mentioned embodiments. For example, the content extractor may generate the content piece in accordance with the degree of difference in the primary evaluations between multiple terminal units 20. Another example is that the content extractor may generate the content piece in accordance with the degree of difference between a predicted evaluation which is preliminarily input, and an actual evaluation (one example is a part of a content predicted to be evaluated “positive”, and actually evaluated “negative”. Another example is a part large amount of the primary evaluation predicted, and actually no primary evaluation conducted).

The content piece may be generated by preliminarily dividing a content into a plurality of sections, and selecting one a plurality of sections. The content piece may comprise at least one of a still picture of a moment of a content or a sound. The terminal unit 20 applying the described case enables a viewer or an auditor to smoothly conduct the secondary evaluation, when the network NW connection between the server unit 10 and the terminal unit 20 is inferior, or capability of the terminal unit 20 to process movie is low.

[Form of the Secondary Evaluation]

While some examples of forms are described in the above-mentioned embodiments, a form of the secondary evaluation is not restricted to those described in the above-mentioned embodiments. For example, a form of the secondary evaluation may be a graduated assessment for each criteria such as “eloquent”, “persuasive” etc. Another example of a form of the secondary evaluation may be providing a model case to compare to the content piece actually extracted. In addition, although a form of the primary evaluation and a form of the secondary evaluation are different in the above-mentioned embodiments, a form of the primary evaluation and a form of the secondary evaluation may be the same.

While the server unit 10 generated the content piece in the above-mentioned embodiments, the terminal unit 20 may generate the content piece. In this case, the terminal unit 20 may send the primary evaluation together with the secondary evaluation to the server unit 20 when the secondary evaluation completed.

While the primary evaluation includes a time-point information in the above-mentioned embodiments, the primary evaluation may not include specifically a time-point information. For example, when a content is preliminarily divided into a plurality of sections, the primary information may only include an information of a section presented at a moment the primary evaluation is made.

When a content to evaluate is an audio content, the content presentation area 41 in Drawing 5 may not exist. When the content piece to evaluate is an audio content piece, the content piece presentation area 51 in Drawing 6 and Drawing 7 may not exist.

All the above-mentioned terminal unit, the server composition, the routine, the form of output and input are just examples, and arbitrarily selected or changed in accordance with a use application. For example, each step in a routine may be processed at an any unit.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A content evaluator comprising:
a primary evaluation accepter which accepts a primary evaluation and records the primary evaluation, the primary evaluation being made by sequentially evaluating a content, the primary evaluation including an evaluation time-point information indicating a point of time that each of the primary evaluation is made;
a content piece extractor which identifies an extraction part in accordance with the primary evaluation and generates a content piece as a part of the content in accordance with the extraction part;
a content piece presenter which presents the content piece; and
a secondary evaluation acceptor which accepts a secondary evaluation on the content piece.

2. The content evaluator of claim 1, further comprising a content recorder which records at least one of an image of the content and a sound of the content, and the recorder is consolidated with the primary evaluation accepter and the secondary evaluation acceptor.

3. A content evaluation system comprising:
a primary evaluation accepter which accepts a primary evaluation and records the primary evaluation, the primary evaluation being made by sequentially evaluating a content, the primary evaluation including an evaluation time-point information indicating a point of time that each of the primary evaluation is made;
a primary evaluation information sender which sends the primary evaluation information a through data transmission path;
a primary evaluation information receiver which receives the primary evaluation information through the data transmission path;
a content piece extractor which identifies an extraction part in accordance with the primary evaluation and generates a content piece as a part of the content in accordance with the extraction part;
a content piece sender which sends the content piece through the data transmission path;
a content piece receiver which receives the content piece through the data transmission path;
a secondary evaluation acceptor which accepts a secondary evaluation on the content piece;
a secondary evaluation information sender which sends the secondary evaluation information through the data transmission path; and
a secondary evaluation information receiver which receives the secondary evaluation information through the data transmission path.
